(19) United States
(12) Patent Application Publication
(10) Pub. No.: US 2002/0154007 A1
(43) Pub. Date: Oct. 24, 2002

(54) Car reverse alerting and multi-functional display

(76) Inventor: Tsan-Lung Yang, Taipei (TW)

Correspondence Address: DOUGHERTY & TROXELL, SUITE 1404, 5205 LEESBURG PIKE, FALLS CHURCH, VA, 22041, US

(21) Appl. No.: 09/838,112

(22) Filed: Apr. 20, 2001

(51) Int. Cl. B60Q 1/00

(52) U.S. Cl. 340/456; 340/425.5; 359/871; 340/815.4; 340/691.6; 340/461; 362/494; 348/148

(57) ABSTRACT

A car reverse alerting and multi-functional display is disclosed. A display and trumpet are mounted on the multi-functional rear view mirror of a car. A charge coupling device, a microphone, and a car reverse sensor for monitoring the images, sounds and distance at a backside of the car are installed. The monitored analog electronic signals are decoded through a decoder so that the electronic signal is converted into a digital signal from an analog signal. Then, these signals are transferred to the multi-functional rear view mirror by cable or wireless devices. Then the signals are processed by a central processing unit. Then an image signal is outputted to a display for displaying; and meanwhile, the display outputs the sound signal from the microphone. The driver can reverse a car safely from the image and speech alert.

### 1. FIELD OF THE INVENTION

The present invention relates to a car reverse alerting and multi-functional display, wherein a display and a trumpet are mounted to a multi-functional rear view mirror, thereby, a driver can reverse a car safely from the image and speech alert. Furthermore, by externally connected devices of the display and trumpet, the driver can view a DVD or TV program, play TV game or call by hand-free mobile phone and other functions.

### 2. BACKGROUND OF THE INVENTION

With the progress of current vehicle technology and the improvement of human life, the car reverse alerting system has become standard equipment of a car gradually. Referring to FIG. 1, a structural block diagram of a car reverse alerting system is illustrated. A car reverse sensor 11 is mounted to a rod of a car. The signal from the car reverse alerting system is reflected by infrared ray and then is received so as to sense the distance between the backside of the car to an obstacle. Then an analog signal is generated. This analog signal is decoded by a decoder 12 and then is converted into digital signal. After the operation of a central processing unit 13, the digital signal is transferred to a buzzer 14 in the driver seat of the car. In the preset distance of the car reverse sensor 11, buzz sounds are emitted for informing the user not to be near the obstacle. This prior car reverse alerting system has the following defects. The buzzer 14 only emits buzz sounds, while the distance to the obstacle can not be acknowledged and moreover, the whole process can not be monitored by viewing. If a sudden condition (such as a person or an animal runs into the distance) occurs, the car reverse alerting system can not be used to sense this condition. Thus, the effect of the car reverse alerting system is bad and is necessary to be improved.

### SUMMARY OF THE INVENTION

Accordingly, the primary object of the present invention is to provide a car reverse alerting and multi-functional display, wherein a driver can reverse a car safely from image and speech alerts.

Another object of the present invention is to provide a car reverse alerting and multi-functional display, wherein by the externally connected devices of the display and trumpet, the driver may view a DVD or TV program, play TV game or call by hand-free mobile phone and other functions.

The various objects and advantages of the present invention will be more readily understood from the following detailed description when read in conjunction with the appended drawing.

### BRIEF DESCRIPTION OF THE DRAWINGS

FIG. 1 is a structural schematic view of a prior car reverse alerting device.

FIG. 2 shows a preferred embodiment of the car reverse alerting system of the present invention.

FIG. 3 is a further embodiment of the car reverse alerting system of the present invention.

FIG. 4 is a structural schematic view showing that a microphone system is installed in the multi-functional rear view mirror of the present invention.

FIG. 5A shows a preferred embodiment in that the multi-functional rear view mirror of the present invention is connected to a display.

FIG. 5B shows a further preferred embodiment in that the multi-functional rear view mirror of the present invention is connected to a display.

FIG. 5C shows a yet preferred embodiment in that the multi-functional rear view mirror of the present invention is connected to a display.

FIG. 6 is a schematic rear view showing that the car reverse alerting system of the present invention is installed in a car.

FIG. 7 is a schematic lateral view showing that the car reverse alerting system of the present invention is installed in a car.

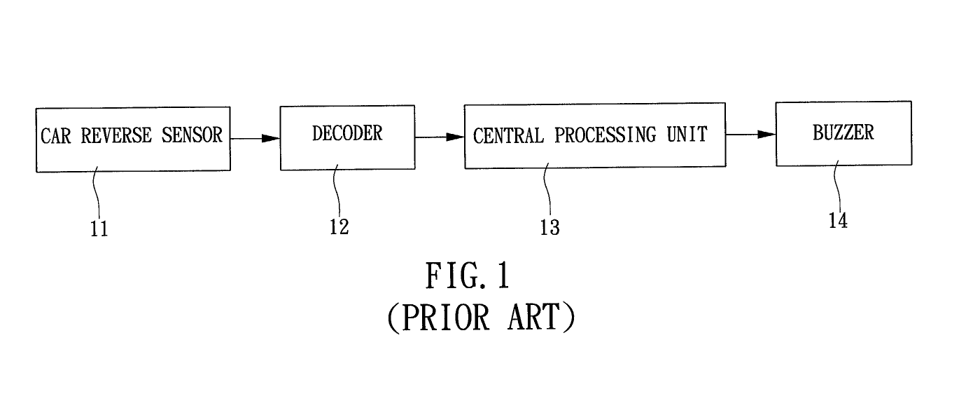

### DETAILED DESCRIPTION OF THE PREFERRED EMBODIMENTS

A car reverse alerting and multi-functional display is disclosed, in that a multi-functional rear view mirror is installed with a display and a speech trumpet. The driver may reverse a car by speech and image simultaneously. Furthermore, by the externally connected devices of the display and trumpet, the driver may view a DVD or TV program, play TV game or call by hand-free mobile phone and other functions.

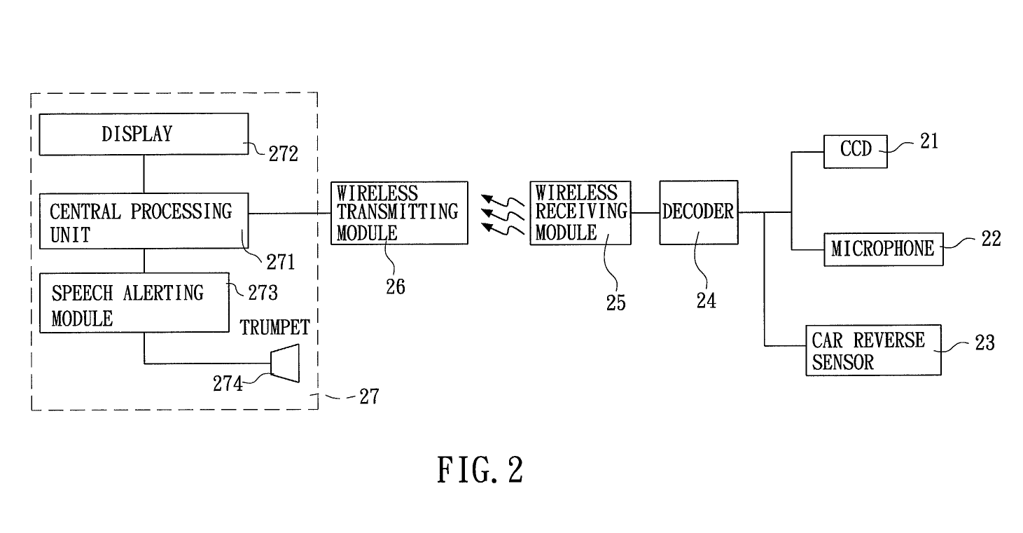

Referring to FIG. 2, a preferred embodiment of the car reverse alerting system is illustrated. At proper positions of a car body is installed with a charge coupling device 21, a microphone 22, and a car reverse sensor 23 for monitoring the images, sounds and distance at the backside of the car. The charge coupling device 21 is a micro-type camera commonly used to a computer for capturing images and then converting the image into electronic signals. The charge coupling device 21 is connected to the microphone 22 which can be used to capture the sound at the backside of a car. Thereby, it is helpful for the judgement of the driver. The microphone 22 can be built in the charge coupling device 21 so that the device is reduced in volume. By the car reverse sensor 23 to emit and receive supersonic wave, the distance between the backside of the car and the obstacle can be detected. The distance can be transferred by an electronic signal to display a correct distance (for example 3 meters, 2 meters, 1 meters, 0.5 meters). The condition of reversing a car can be handled precisely

The electronic signals from the charge coupling device 21, microphone 22, and car reverse sensor 23 can be decoded through a decoder 24 so that the electronic signal is converted into a digital signal from an analog signal. Then, a wireless transmitting module 25 installed at the backside of the car transfers the signal. The signal is received a multi-functional rear view mirror 27 through a wireless receiving module 26 at the front side and then is processed by a central processing unit 271. Then an image signal is outputted to a display 272 for displaying. Meanwhile, the display 272 outputs the sound signal from the microphone 22. In the central processing unit 271, the distance signal is processed by a speech alerting module 273 so that the distance from the backside of the car to the obstacle is detected by the car reverse sensor 23 and is outputted as speech. Then a trumpet 274 will emit the sound of the speech to inform a correct distance to the driver.

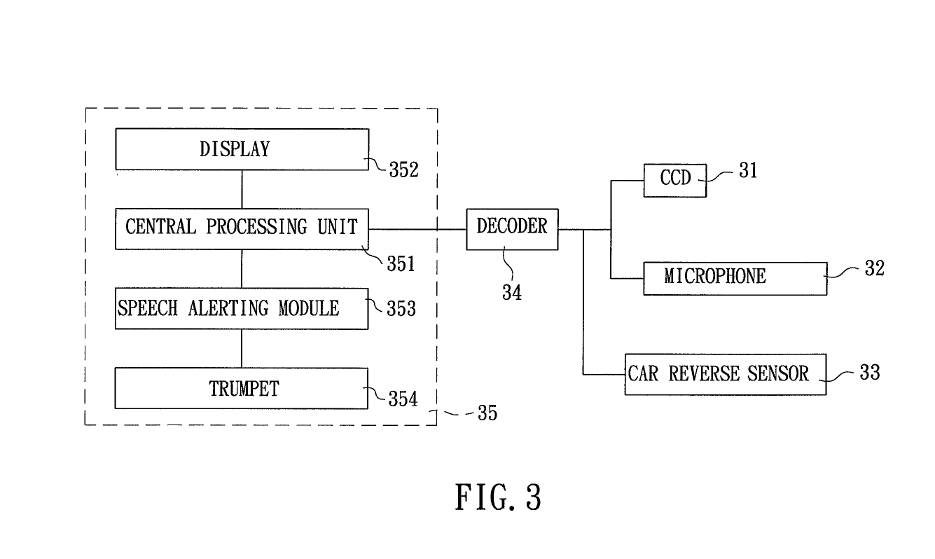

Abovesaid shows a wireless alarm function of the present invention for informing the car is reversed now, while the transformation of the present invention can be performed by cable. With reference to FIG. 3, at proper positions of a car body is installed with a charge coupling device 31, a microphone 32, and a car reverse sensor 33 for monitoring the images, sounds and distance at the backside of the car. The charge coupling device 31 is a micro-type camera commonly used to a computer for capturing images and then converting the image into electronic signals. The charge coupling device 31 is connected to the microphone 32 which can be used to capture the sound at the backside of a car. Thereby, it is helpful for the judgement of the driver. The microphone 32 can be built in the charge coupling device 31 so that the device is reduced in volume. By the car reverse sensor 33 to emit and receive supersonic wave, the distance between the backside of the car and the obstacle can be detected. The distance can be transferred by an electronic signal to display a correct distance (for example 3 meters, 2 meters, 1 meters, 0.5 meters). The condition of reversing a car can be handled precisely

The electronic signals from the charge coupling device 31, microphone 32, and car reverse sensor 33 can be decoded through a decoder 34 so that the electronic signal is converted into a digital signal from an analog signal. The signal is transferred to a multi-functional rear view mirror 35 and then is processed by a central processing unit 351. Then an image signal is outputted to a display 352 for displaying. Meanwhile, the display 352 outputs the sound signal from the microphone 32. In the central processing unit 351, the distance signal is processed by a speech alerting module 353 so that the distance from the backside of the car to the obstacle is detected by the car reverse sensor 33 and is outputted by speech. Then a trumpet 354 will emit the sound of the speech to inform a correct distance to the driver.

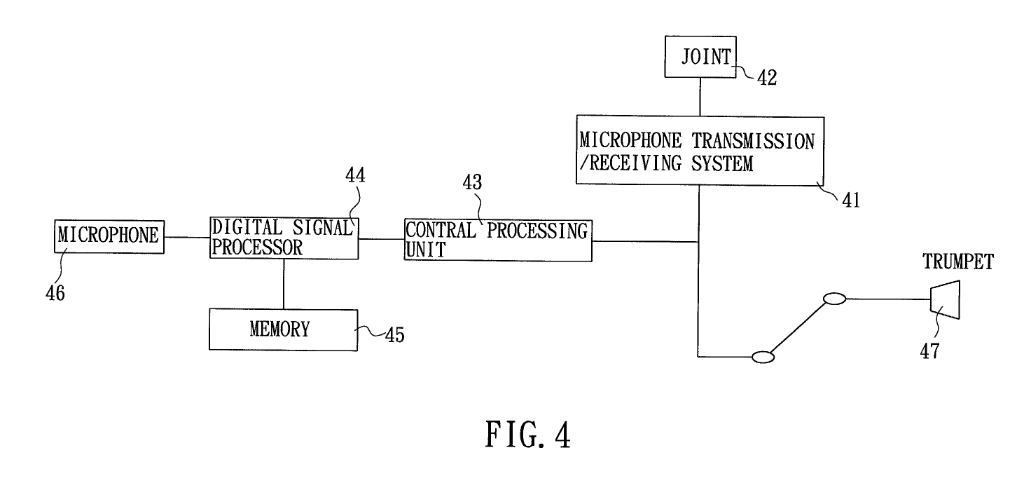

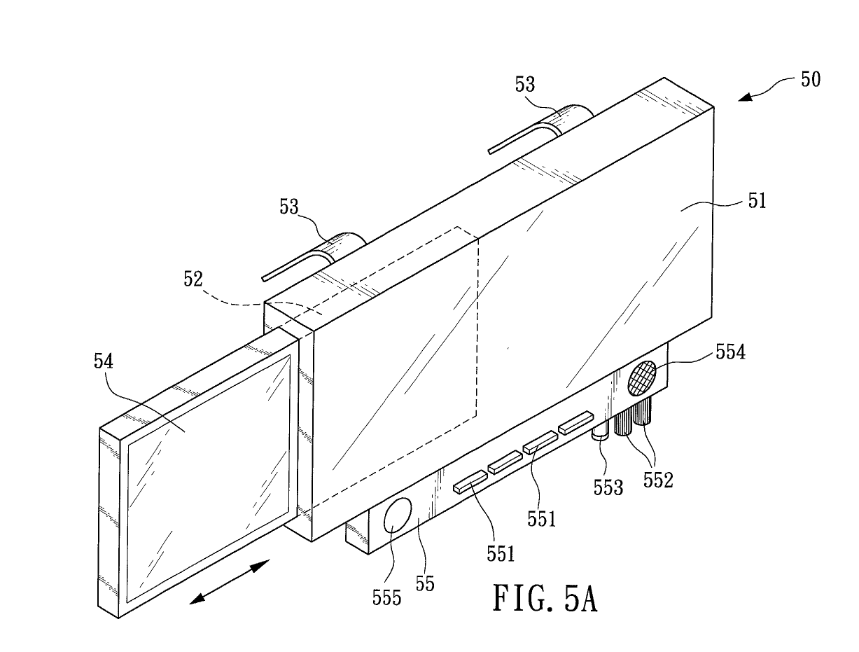

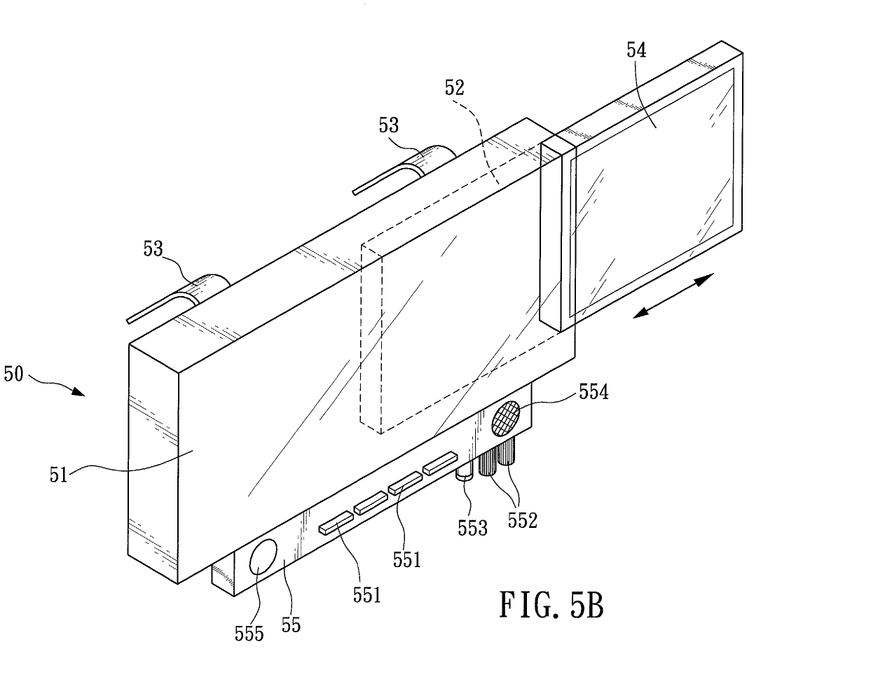

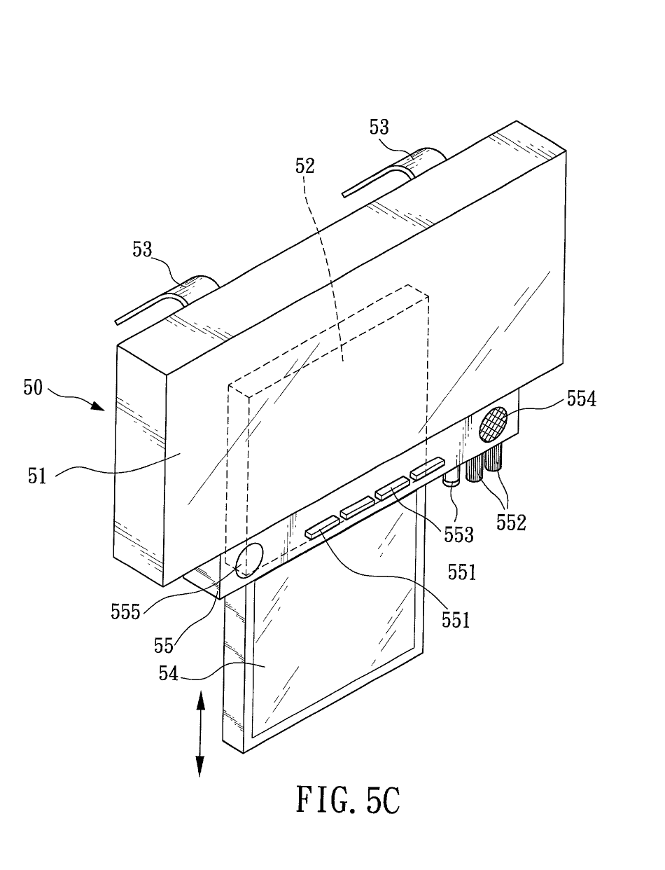

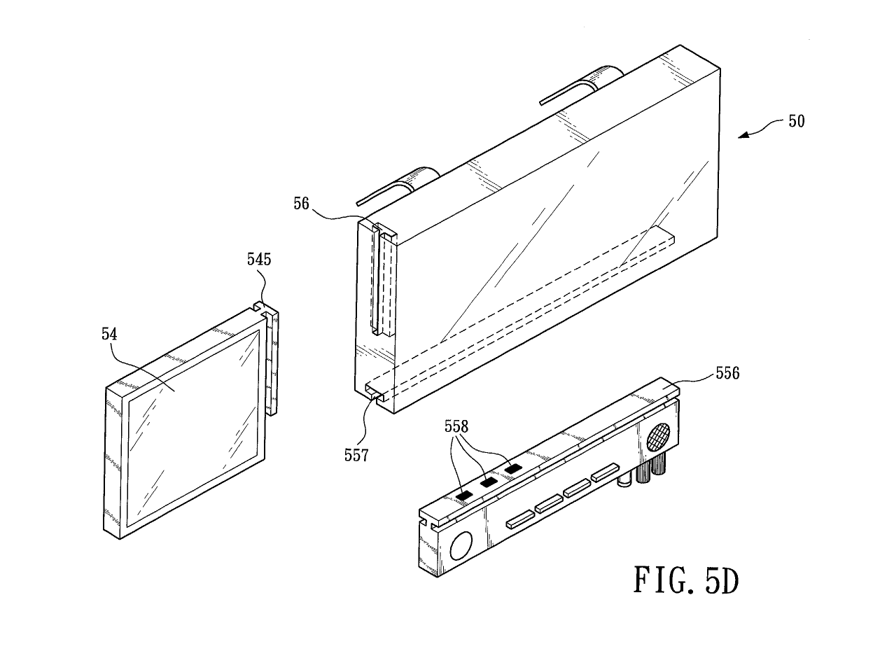

Referring to FIG. 4, a structural schematic view is illustrated, wherein the multi-functional rear view mirror of the present invention is installed with a mobile phone system. The structure of the multi-functional rear view mirror will be described hereinafter with reference to FIGS. 5A, 5B and 5C. The transmission/receiving system of the mobile phone 41 is inserted into the port (not shown) of the mobile phone of the driver. When the driver uses the mobile phone, the external speech signal is amplified through a trumpet 47. When the driver speaks to the microphone 46, the speech signal is processed through a digital signal processor 44 and then the speech signal is registered through a memory 45. After the speech is operated through a central processing unit 43, it is converted into the speech format of the mobile phone by the mobile phone transmission/receiving system. Further, through the mobile phone connected to the joint 42, the signal is transferred out through the built-in emitting module in the mobile phone so as to be formed with a hand-free structure of a microphone.

In the aforesaid structure, the mobile phone of the driver may transmit and receive speech signal through the hand-free receiver built in the multi-functional rear view mirror. Moreover, in the present invention, the multi-functional rear view mirror 27 can be built with a mobile phone module and keys, so that it is unnecessary for the driver to further buy a microphone, while the mobile phone can be used in a car. The dial-up and receiving of the mobile phone built in the multi-functional rear view mirror can be performed by speech or keying.

Referring to FIGS. 5A, 5B and 5C, the front side of the multi-functional rear view mirror 50 has a mirror surface 51 which is installed in a car for reflecting the image at the backside of a car. The multi-functional rear view mirror 50 in FIG. 5A has a receiving groove 52 at the left side. The installation of the receiving groove 52 is not confined to this way. In FIG. 5B, the receiving groove 52 is installed at the left side of the FIG. 5B. In FIG. 5C, the receiving groove 52 is installed at the lower side for receiving a display 54. Therefore, the receiving groove can be mounted at the left or right side for suiting the driver seats of various nations. When the display 54 is used, a button is pressed or a manual operation is performed for pulling out or receiving the display 54 from or in the multi-functional rear view mirror 50. Two hooks 53 are mounted at the upper edge of the multi-functional rear view mirror 50. Thereby, the multi-functional rear view mirror can be hooked to the rear view mirror (not shown) in a car. A control panel 55 is installed below the multi-functional rear view mirror 50. A plurality of buttons 552 is installed at a front side of the control panel 55. A trumpet 554 is mounted at the front right side of the control panel 55. A microphone 554 is mounted at the front left side of control panel 55. A plurality of buttons 552 are installed below the control panel 55. By the installation of the buttons 551 and trumpet 554, the display 54, trumpet 554, and microphone 555 can be adjusted. The display 54 can be combined to an antenna module for receiving the TV program wirelessly transmitted. The display 54 has an AV terminal port (not shown) for being further combined with a DVD player, TV game machine, etc., so that the multi-functional rear view mirror 50 has the functions of displaying movies, playing TV games and other functions.

With reference to FIG. 5D, a preferred embodiment showing the display and control panel of the present invention being embedded into a multi-functional rear view mirror is illustrated. One lateral side of the multi-functional rear view mirror 50 is installed with a first sliding groove 56 for a sliding track 545 installed on the display 54 to be buckled downwards so as to fix the multi-functional rear view mirror 50 to the display 54. At the connecting surface of the first sliding track 545 with respect to the first sliding groove 56, a plurality of metal joints (not shown) are installed for being connected with the power source and signal source of the display 54. Furthermore, the bottom of the multi-functional rear view mirror 50 is formed with a second sliding groove 557 for being buckled by a second sliding track 556 installed above the control panel 55 from the left side of the multi-functional rear view mirror 50 so as to fix the multi-functional rear view mirror 50 to the control panel 55. A plurality of metal joints 558 are formed at the connecting surface of the second sliding track with respect to the first sliding groove 556 so that the electric control signals of the multi-functional rear view mirror 50 and the control panel 55 are connectable with one another. By the buckling structure of the multi-functional rear view mirror 50, display 54 and the control panel 55, the three can be assembled and detached freely for classifying the products (if the display 54 is unnecessary, it is not assembled. It is only necessary to combine the multi-functional rear view mirror to the control panel 55. The car reverse alerting system has only the speech function for informing). Therefore, the user may buy the product according to the requirement and cost. Therefore, the present invention can be assembled by many ways and has commercially worth.

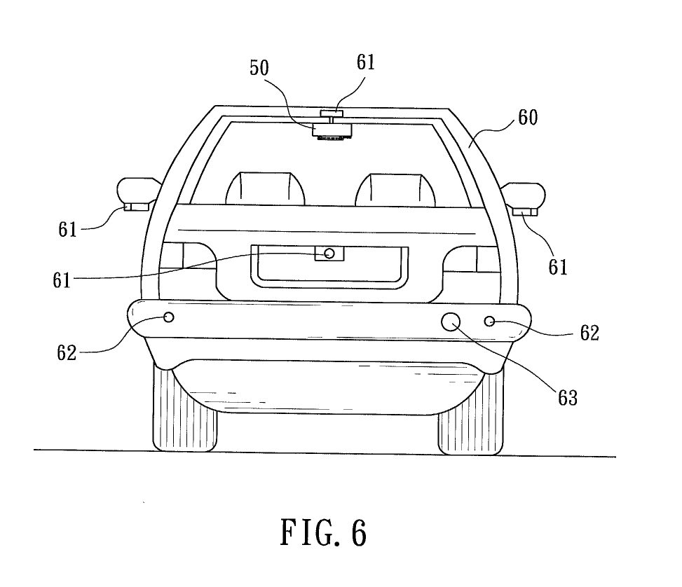

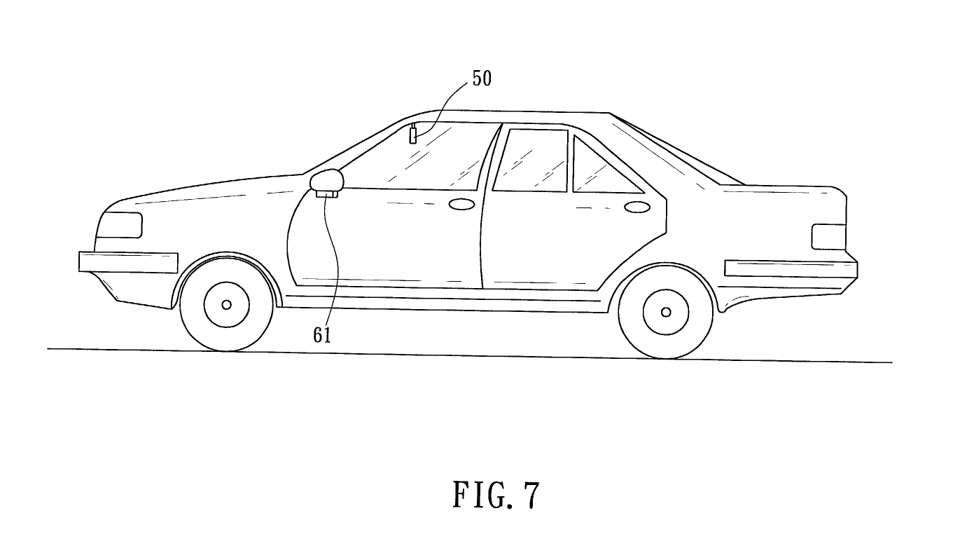

With reference to FIGS. 6 and 7, a schematic rear view showing the car reverse alerting system of the present invention being installed to a car and a schematic lateral view showing the car reverse alerting system of the present invention being installed to a car are illustrated. In the outer side of the car casing, each of the upper side of the rear window, rear view mirrors at the right and left sides, even the upper side of the car number plate is installed with a charge coupling device 61 for monitoring the rear side of the car. Two sides of the safety rods of the car can be installed with car reverse sensor 62, respectively, for detecting the distance to the rear side of the car with the obstacle. A microphone 63 is installed the at the middle portion of the two car reverse sensors 62 for capturing the sound at the backside of the car so that the driver may give a correct judgement.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A car reverse alerting and multi-functional display having a mirror surface at a front side of a multi-functional rear view mirror and a receiving groove at a left side of the multi-functional rear view mirror for receiving a display, wherein when a driver is desired to use the display, a button is pressed or a manual operation is performed for pulling out or receiving the display from the multi-functional rear view mirror;
two hooks being mounted at an upper edge of the multi-functional rear view mirror, thereby, the multi-functional rear view mirror being hooked to a rear view mirror within a car;
a control panel being installed below the multi-functional rear view mirror; a plurality of pressable buttons being installed at a front central portion of the control panel; a trumpet being installed at a right front side of the control panel; a microphone being installed at a left front side of the control panel; and a plurality of rotatable buttons being installed below the control panel; the pressable buttons and rotatable buttons serving to adjust the display, trumpet, and microphone;
wherein the display of the multi-functional rear view mirror is used to be combined with an antenna module for receiving a TV program wireless transmitted; the display has AV ports for being further combined with a DVD player, a TV game machine, and other external devices so that the multi-functional rear view mirror has functions of playing movies, playing TV games, and other functions.

2. The car reverse alerting and multi-functional display as claimed in claim 1, wherein the display is installed at a right side of a multi-functional rear view mirror for suiting the rules of various nations.

3. The car reverse alerting and multi-functional display as claimed in claim 1, wherein the display is installed at a lower side of a multi-functional rear view mirror.

4. The car reverse alerting and multi-functional display as claimed in claim 1, wherein the multi-functional rear view mirror is installed with a mobile phone system; the transmission/receiving system of the mobile phone is inserted into ports of the mobile phone of the driver; when the driver uses the mobile phone, an external speech signal is amplified through a trumpet; when the driver speaks to the microphone, the speech signal is processed through a digital signal processor and then the speech signal is registered through a memory; after the speech signal is operated through a central processing unit, it is converted into a speech format of the mobile phone by the mobile phone transmission/receiving system; further, through the mobile phone connected to a joint, the signal is transferred out through a built-in emitting module in the mobile phone so as to be formed with a hand-free structure of a microphone.

5. The car reverse alerting and multi-functional display as claimed in claim 1, wherein the dial-up keys of the mobile phone is built in the multi-functional rear view mirror, thereby the user can use a microphone in a car without needing to buy another microphone.

6. The car reverse alerting and multi-functional display as claimed in claim 1, wherein the display and control panel of the multi-functional rear view mirror are installed with matched buckling means for assembling or detaching the display and the control panel.

7. A car reverse alerting system, wherein a car is installed with a charge coupling device, a microphone, and a car reverse sensor for monitoring images, sounds and distance at a backside of the car; electronic signals from the charge coupling device, microphone, and car reverse sensor are decoded through a decoder so that the electronic signal is converted into a digital signal from an analog signal; then, a wireless transmitting module installed at the backside of the car transfers the signal; the signal is received by the multi-functional rear view mirror through a wireless receiving module at a front side of the car and then is processed by a central processing unit; then an image signal is outputted to a display for displaying; meanwhile, the display outputs the sound signal from the microphone; in the central processing unit, the signal is processed by a speech alerting module so that the distance from the backside of the car to the obstacle is detected by the car reverse sensor and is outputted using speech way; then a trumpet emits a sound of the speech to inform a correct distance to the driver.

8. The car reverse alerting system as claimed in claim 7, wherein the charge coupling device is a micro-type camera commonly used in a computer for capturing images and then converting the image into electronic signals.

9. The car reverse alerting system as claimed in claim 7, wherein the charge coupling device is connected to the microphone; thereby, it is helpful for the judgement of the driver; and the microphone is built in the charge coupling device so that the device is reduced in volume.

10. The car reverse alerting system as claimed in claim 7, wherein the car reverse sensor is used to emit and receive supersonic wave, the distance between the backside of the car and the obstacle is detected.

11. The car reverse alerting system as claimed in claim 7, wherein a cable is used to replace the wireless transmitting module and the wireless receiving module.
